(19) United States
(12) Patent Application Publication
(10) Pub. No.: US 2012/0248092 A1
(43) Pub. Date: Oct. 4, 2012

(54) LOW TEMPERATURE THERMISTOR PROCESS

(75) Inventors: Scott Albert Uhland, San Jose, CA (US); Jurgen H. Daniel, San Francisco, CA (US); Gregory Lewis Whiting, Mountain View, CA (US)

(73) Assignee: PALO ALTO RESEARCH CENTER INCORPORATED, Palo Alto, CA (US)

(21) Appl. No.: 13/076,375

(22) Filed: Mar. 30, 2011

(51) Int. Cl. H05B 3/03; H01C 17/02

(52) U.S. Cl. 219/546; 29/611

(57) ABSTRACT

A thermistor has a mixture of a temperature sensitive material and a conductive material, and an electrode in electrical contact with the mixture. A method of manufacturing a thermistor includes depositing conductive contacts onto a substrate, printing a thermistor mixture of temperature sensitive material and a conductive material over the contact, and annealing the thermistor mixture to produce a flexible thermistor on the conductive contacts.

### BACKGROUND

Flexible electronics have applications in many different areas. The development of functional materials that can be solution processed and are compatible with flexible substrates has lead to interest in developing electronic devices for applications that would otherwise not be possible. Many of these substrates involve metalized polymers or other ‘soft’ materials. In some instances, the circuitry may be printed onto the flexible substrates using conductive materials.

However, certain components do not adapt well to flexible electronics technology or being formed by printing. For example, certain types of resistors have resistance that varies significantly with temperature, called thermistors. Thermistors typically consist of sintered semiconductor materials typically manufactured on rigid substrates using a slurry that requires high temperature annealing (800-1000° C.). These high temperatures render thermistors incompatible with flexible electronics technology, as the high temperatures would cause the substrates to melt.

With rising interest in flexible, printed electronics, applications exist that would benefit from flexible, printable, inexpensive thermistors. These applications include, but are not limited to, flexible temperature sensors for bandages, printable temperature sensors for packaging labels, and polymer and other flexible circuits with temperature sensors.

### BRIEF DESCRIPTION OF THE DRAWINGS

FIG. 1 shows an example of a lateral contact, low temperature processed flexible printed thermistor.

FIG. 2 shows an embodiment of a vertical contact, low temperature processed flexible printed thermistor.

FIG. 3 shows a flowchart of an embodiment of a method to manufacture a low temperature processed flexible printed thermistor.

FIG. 4 shows a graph of temperature vs. resistance for a low temperature processed flexible printed thermistor

FIG. 5 shows a graph of resistance and temperature vs. time for a low temperature processed flexible printed thermistor

### DETAILED DESCRIPTION OF THE EMBODIMENTS

Currently, most thermistor processing is done at high temperatures in the range of 800-1000° C., incompatible with plastic or polymer flexible substrates. Some work has occurred using polymer-based thermistors, documented in Synthetic Materials, Vol. 159, “Thermistor Behavior of PEDOT:PSS Thin Film,” pp. 1174-1177, (2009). Here, thermistors were fabricated using a thin film of poly (3,4-ethylenedioxythopher): poly (4-styrenesulfonate) (PEDOT:PSS) spin-coated onto a silicon wafer. While the material was processed at lower temperatures than conventional thermistor technology, the substrate consisted of an inflexible silicon wafer and processing temperatures of 150 and 200° C. border on melting temperatures for many flexible substrates.

However, the inventors have discovered that mixing currently used temperature responsive thermistor materials with relatively low melting point conductive materials that have solder-like qualities results in a thermistor with desirable properties. The resulting thermistor has high sensitivity, meaning that it experiences large change of resistance for a given change in temperature, can be processed at temperatures compatible with flexible substrates, and can undergo deposition in an inexpensive printing process.

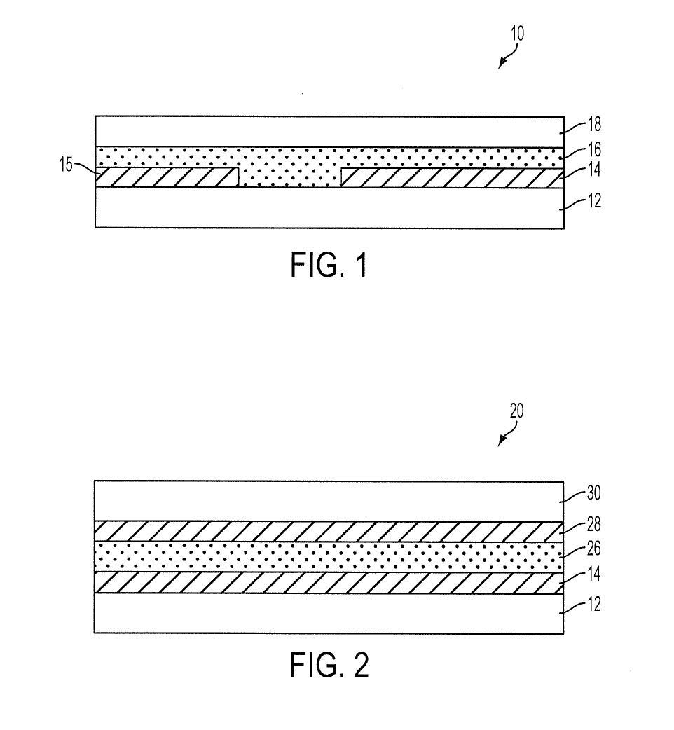

FIGS. 1 and 2 show two different architectures of low temperature processed thermistors. FIG. 1 shows an embodiment of a lateral contact, low temperature processed thermistor 10. The term ‘lateral contact’ refers to the configuration of the contacts 14 and 15 that reside on either side of the temperature sensitive material 16. The substrate 12 will typically consist of a flexible material such as PET (polyethylene terephthalate) or PEN (polyethylene napthalate) which are suitable for many flexible electronics applications.

Conductive electrical contacts (electrodes) 14 and 15 are deposited onto the substrate 12. The conductive contacts may consist of any type of conductive material. In the embodiments discussed here, the contacts typically consist of silver. Similarly, deposition of the conductive contacts may involve any type of deposition compatible with the relatively low temperatures. In one embodiment the contacts may be printed onto the substrate. This has advantages for patterning and alignment control through print-type processing.

The thermistor mixture in this embodiment will generally consist of a temperature sensitive material mixed with a low melting point electrically conductive matrix, such as solder-like materials. The temperature sensitive material has temperature sensitivity in that the resistance of the material varies significantly with temperature. The material may show either a positive thermal coefficient (PTC, increase in resistance with increasing temperature) or negative thermal coefficient (NTC, decrease in resistance with decreasing temperature). In one example, the temperature coefficient of resistivity of the thermistor mixture is at least 1-2% per ° C. In one embodiment, the temperature sensitive material consisted of vanadium pentoxide (V₂O₅). Other possible temperature sensitive materials include other metal oxides such as zinc oxide, vanadium oxides or other materials such as silicon or germanium.

The conductive material may have solder-like qualities in that it melts at relatively low temperatures under 160° C. Typically, a eutectic mixture will be used, where the mixture of materials has the lowest melting point of any mixture of the two materials, such as an indium tin (InSn) eutectic.

In one embodiment, InSn was used. Other possible materials include mixtures of indium, tin, silver, bismuth, cadmium, lead, and zinc. Alternatively, the conductive phase may be made of a pure material such as a silver, indium tin oxide or carbon particulate solution. In the embodiment of FIG. 1, the thermistor mixture 16 fills the gap between the lateral conductive contacts 14 and 15.

In some instances, the thermistor structure may benefit from an encapsulant 18. In some instances, the thermistor material may be highly hydroscopic in that it takes on water easily, having a negative impact on its performance. Using an encapsulant can alleviate that issue. Possible flexible encapsulates include polymer films or flexible metal films.

FIG. 2 shows an embodiment of a vertical contact, low temperature processed, printed flexible thermistor 20. The term ‘vertical’ means that the temperature responsive material 26 lies between a bottom contact layer 14, which lies on the substrate 12, and a top contact layer 28. The encapsulant 30 in this embodiment lies on the top contact layer 28, rather than on the temperature sensitive material 26.

These two embodiments provide examples of possible configurations of low temperature processed printed flexible thermistors. Any configuration of conductive contacts may be used and are considered to be within the scope of the claims.

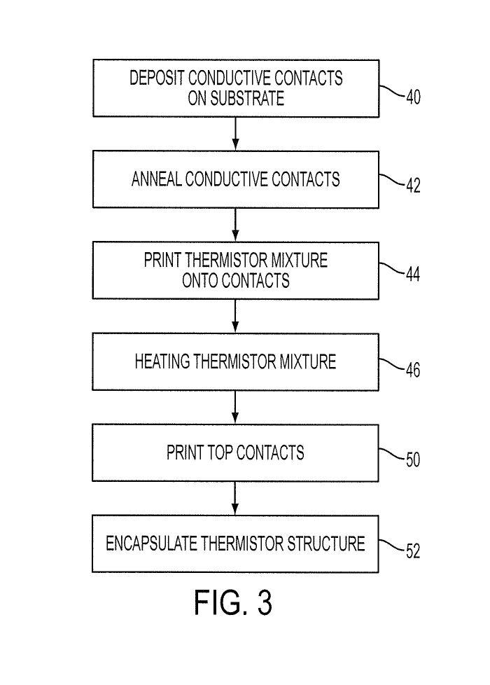

FIG. 3 provides an embodiment of a general process to manufacture a thermistor such as those shown in FIGS. 1 and 2. Depending upon the configuration of the thermistor chosen as well as the materials used, the process may change. The discussion will include these changes and modifications throughout the discussion.

In FIG. 3, the process begins by deposition of conductive contacts 40 onto a flexible substrate such as PET (polyethylene terephthalate) or PEN (polyethylene naphthalate). As discussed above, the conductive contacts may consist of silver printed onto the substrate such as by screen, gravure, flexographic or ink-jet printing. Depending upon the process and materials used, the conductive contacts may undergo a first annealing step to dry any solvent used during the printing process and to sinter the materials at 42.

The thermistor mixture is then printed onto the conductive contacts at 44. Again, the process may include any type of printing such as screen, flexographic printing, ink-jetting, etc. The thermistor material then undergoes reflowing and annealing by application of heat at 46. The temperature used will typically be around the eutectic point of the system plus some delta, such as 10° C. This treatment significantly lowers the resistivity of the printed ink, lowering the resistance of the resulting thermistor. In the embodiment of an unencapsulated lateral type device, this may end the process.

In another embodiment that employs an encapsulant, the process may move to the encapsulation process at 52. At this stage this will involve thermistors that do not have a top contact, such as the lateral embodiment discussed in FIG. 1.

For the sandwich configuration of FIG. 2, the process moves to the printing of the top contacts at 50, after the reflow and annealing process at 46. For this embodiment, the encapsulation of the completed device is carried out after printing of the top contact.

One should note that use of printing processes in combination with these materials may make possible high volume production in a roll-to-roll or web-fed process of thermistors manufactured inexpensively and in bulk on flexible substrates using temperatures much lower than typically used when preparing thermistors in a more conventional manner.

FIG. 3 provides an overall process at least portions of which apply to many different configurations of thermistors. Without any limitation intended, and none should be implied, the following example is given:

### Example 1

Vanadium pentoxide powder was milled into smaller sized particles, approximately 1-10 microns in size.

A printable solder ink, such as a solder ink commercially available from the Indium Corporation, which is composed of a eutectic mixture of indium and tin combined with a binder such as rosin, was combined with the milled vanadium pentoxide, in this instance at a ratio of 2:1 InSn:V₂O₅ by volume.

Limonene was then added as needed to reduce the viscosity of the ink.

The mixture was deposited using screen printing onto a previously printed set, also deposited using screen printing. of silver traces on a 100 micron thick Mylar® foil.

The substrate, traces and mixture was then heated to 150° C. for 10-15 minutes to cause the mixture to reflow, dry and anneal the printed thermistor ink.

The substrate was then encapsulated, for example by laminating a flexible metal foil over and around the device.

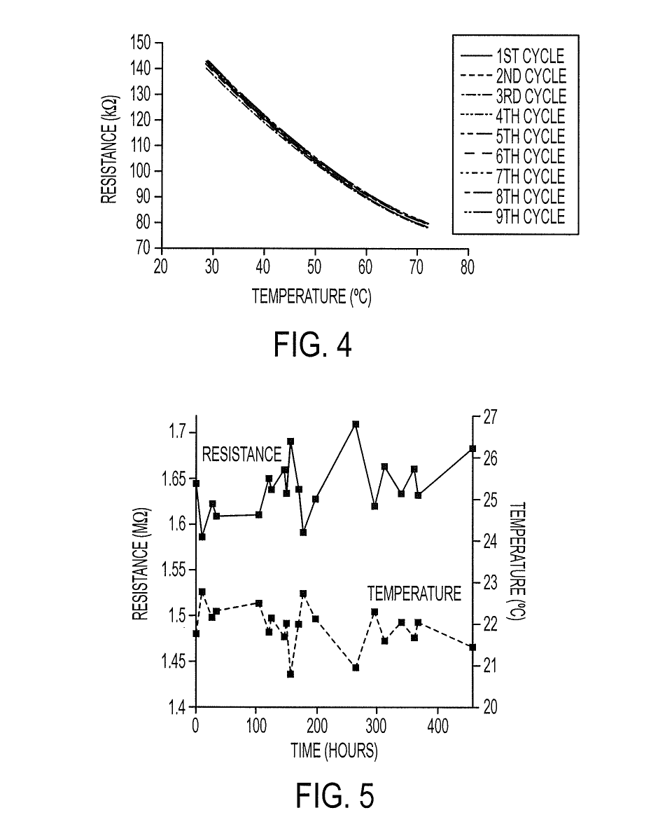

A plot showing resistance versus temperature for a printed, flexible thermistor is shown in FIG. 4. This plot shows 9 separate temperature scans. Note that in this instance the thermistor is a negative temperature coefficient (NTC) thermistor in which the resistance lowers as the temperature rises. The resulting thermistor has a better than +/−1° C. precision under continuous operation.

FIG. 5 shows a graph of the resistance of the completed thermistor versus time for the thermistor stored in air at room temperature for about 2 weeks. Fluctuations in resistance, shown in the top line, are due to, and closely follow, fluctuations in room temperature, shown in the bottom line. This plot indicates that the completed thermistor is stable over longer time periods.

In this manner, one can manufacture thermistors having processing temperatures low enough to allow their manufacture on flexible substrates. These thermistors have high precision even after continuous use and can be manufactured inexpensively and in high volumes using printing technologies.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A thermistor, comprising:
a mixture of a temperature sensitive material and a conductive material; and
an electrode in electrical contact with the mixture.

2. The thermistor of claim 1, wherein the temperature sensitive material comprises one of metal oxide, silicon or germanium.

3. The thermistor of claim 2, wherein the metal oxide comprises one of vanadium oxide or zinc oxide.

4. The thermistor of claim 1, wherein the conductive material comprises one of eutectic mixtures of indium, tin, silver, bismuth, cadmium, lead, zinc, silver, indium tin oxide or carbon particulates.

5. The thermistor of claim 1, wherein the electrode material comprises silver.

6. The thermistor of claim 1, further comprising an encapsulant on the mixture.

7. The thermistor of claim 5, wherein the encapsulant comprises one of a polymer or a mixture of adhesive and metalized foil.

8. A method of manufacturing a thermistor, comprising:
depositing conductive contacts onto a substrate;
printing a thermistor mixture of temperature sensitive material and a conductive material over the contacts; and
annealing the thermistor mixture to produce a flexible thermistor on the conductive contacts.

9. The method of claim 8, further comprising encapsulating the flexible thermistor.

10. The method of claim 9, wherein encapsulating the flexible thermistor comprises depositing a layer of one of a polymer, metalized foil with an adhesive, or parylene.

11. The method of claim 8, further comprising printing top conductive contacts onto the thermistor.

12. The method of claim 11, further comprising annealing the top conductive contacts.

13. The method of claim 12, further comprising encapsulating the top conductive contacts.

14. The method of claim 8, wherein depositing conductive contacts onto the substrate comprises printing the conductive contacts onto a flexible substrate.

15. The method of claim 8, wherein depositing conductive contacts onto a substrate comprises printing the conductive contacts onto a substrate.

16. The method of claim 8, further comprising mixing the thermistor mixture with a solvent prior to printing the thermistor mixture onto the conductive contacts.

17. The method of claim 16, wherein the solvent comprises limonene.

18. The method of claim 8, wherein annealing the thermistor mixture comprises heating the thermistor mixture to approximately 150 degrees Celsius for a time period in the range of 10 to 15 minutes.

19. The method of claim 8, further comprising annealing the conductive contacts prior to printing the thermistor material.
